(19) United States
(12) Patent Application Publication
(10) Pub. No.: US 2019/0234582 A1
(43) Pub. Date: Aug. 1, 2019

(54) LIGHT MODULE FOR ILLUMINATING AN OUTER COMPONENT OF A VEHICLE, AND PROCESS FOR MANUFACTURING SUCH LIGHT MODULE

(71) Applicant: Dura Operating, LLC, Auburn Hills, MI (US)

(72) Inventor: Thomas Farges, Gometz Le Chatel (FR)

(21) Appl. No.: 16/342,276

(22) PCT Filed: Oct. 21, 2016
(86) PCT No.: PCT/EP2016/075439

§ 371 Date: Apr. 16, 2019

(51) Int. Cl. F21S 45/47; F21S 43/14; F21S 43/19; F21S 43/237; F21S 43/243; F21S 43/247; F21S 43/27; F21S 45/49

(52) U.S. Cl. CPC F21S 45/47; F21S 43/14; F21S 43/19; F21S 45/49; F21S 43/243; F21S 43/247; F21S 43/27; F21S 43/237

(57) ABSTRACT

A light module for illuminating an outer component of a vehicle, includes a housing, a cover on the housing, an inner space between the housing and the cover, a circuit board in the inner space, a light source on the circuit board and configured for emitting an illumination beam, and a light guide in the housing facing the light source and extending outside the inner space for guiding the illumination beam along the outer component, and a connection system for connecting the circuit board outside the light module. The housing and the cover are each made of a plastic material; and the cover integrates, on the one hand, the connection system and, on the other hand, a heatsink insert made of metal and having an inner surface in contact with the circuit board and an outer surface extending outside the inner space of the light module.

### TECHNICAL FIELD

The disclosure concerns a light module for illuminating an outer component of a vehicle. The disclosure also concerns a process for manufacturing such light module.

### BACKGROUND

In the automotive field, it is known to illuminate outer components of a vehicle for aesthetic reasons. For example, the outer components can be strips extending along the profile of the vehicle body, such as strips mounted around lateral doors, rear trunk and/or rear windshield. The illumination can be activated in specific conditions, such as braking, doors locking, night detection, or manual control from the dashboard. The illumination can be activated with a specific program, such as intermittent lighting with a predetermined pattern and at a predetermined tempo, or permanent lighting in darkness.

As non-limitative examples, automotive lighting devices are disclosed in documents WO2006086563, WO2015154972 and WO2016112897.

### SUMMARY

The disclosure relates to a light module for illuminating an outer component of a vehicle.

To this end, the disclosure concerns a light module for illuminating an outer component of a vehicle, the light module comprising: a housing for fastening the light module to the vehicle; a cover mounted on the housing; an inner space delimited between the housing and the cover; a printed circuit board mounted in the inner space; a light source mounted on the printed circuit board and configured for emitting an illumination beam; a light guide mounted in the housing facing the light source and extending outside the inner space for guiding the illumination beam along the outer component; and a connection system for connecting the printed circuit board outside the light module. The housing and the cover are each made of a plastic material. The cover integrates, on the one hand, the connection system and, on the other hand, a heatsink insert made of metal and having an inner surface in contact with the printed circuit board and an outer surface extending outside the inner space of the light module.

Thanks to this construction, the heat emitted by the light source is transferred onto the heatsink insert via the printed circuit board. This provides cooling of the light module and prevents the light source from overheating and overaging.

According to further aspects of the disclosure which are advantageous but not compulsory, such a light module may incorporate one or several of the following features:
The light source is mounted on the printed circuit board opposite the heatsink insert.
The light source is mounted on the printed circuit board opposite a central portion of the heatsink insert.
The heatsink insert is made of aluminum alloy.
The connection system comprises at least one pin extending through the cover, and having a first end connected to the printed circuit board and a second end located outside the cover.

The connection system comprises several pins extending through the cover.
The connection system has an inner portion provided with a male configuration and fitted into the printed circuit board.
The connection system has an outer portion provided with a female configuration for receiving a connector plug.
The outer portion is designed to provide a sealed connection once the connector plug is secured therein.

The disclosure also concerns a process for manufacturing a light module as mentioned here-above. The heatsink insert is integrated to the cover by overmolding or fitting.

In a first embodiment of the process, the connection system comprises one or several pins integrated through the cover by overmolding or fitting. Thus, the cover is watertight sealed in the area of the connection system.

In a second embodiment of the process, the connection system comprises one or several pins passing through the cover and fastened to the printed circuit board. The cover is watertight sealed in the area of the connection system when a connector plug is secured in an outer portion of the connection system.

### BRIEF DESCRIPTION OF THE DRAWINGS

Certain embodiments of the invention will now be explained in correspondence with the annexed figures, and as an illustrative example, without restricting the object of the invention. In the annexed figures:

FIG. 1 is an upper view of a light module;

FIG. 2 is a sectional view of the light module along line II-II of FIG. 1;

FIG. 3 is a partial sectional view, at a larger scale, of a detail from FIG. 2; and

FIG. 4 is a sectional view of a second embodiment of a light module, along line IV-IV of FIG. 1.

### DETAILED DESCRIPTION

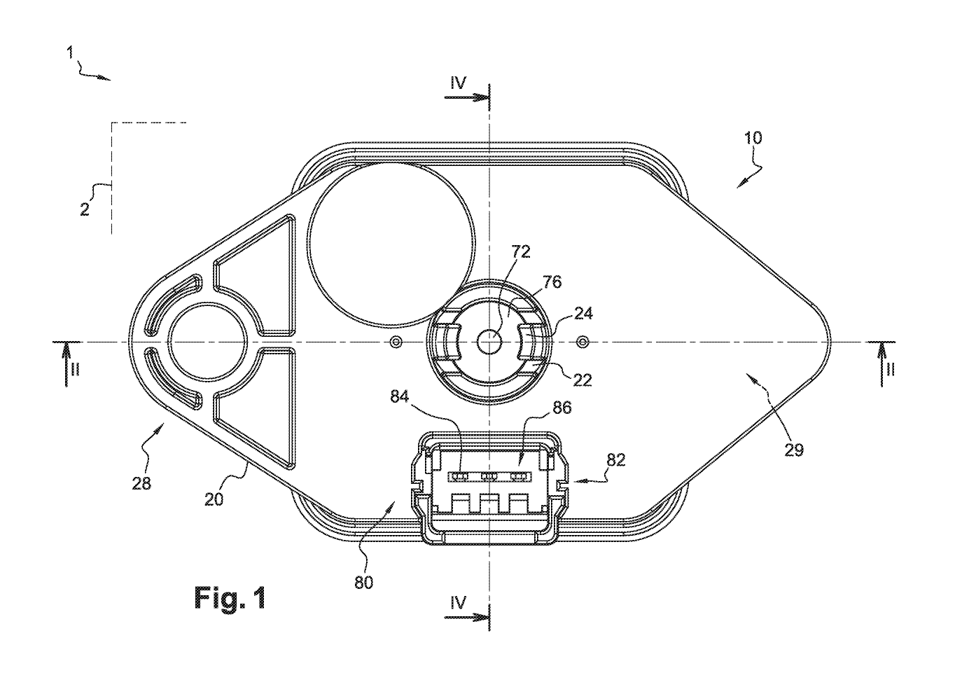

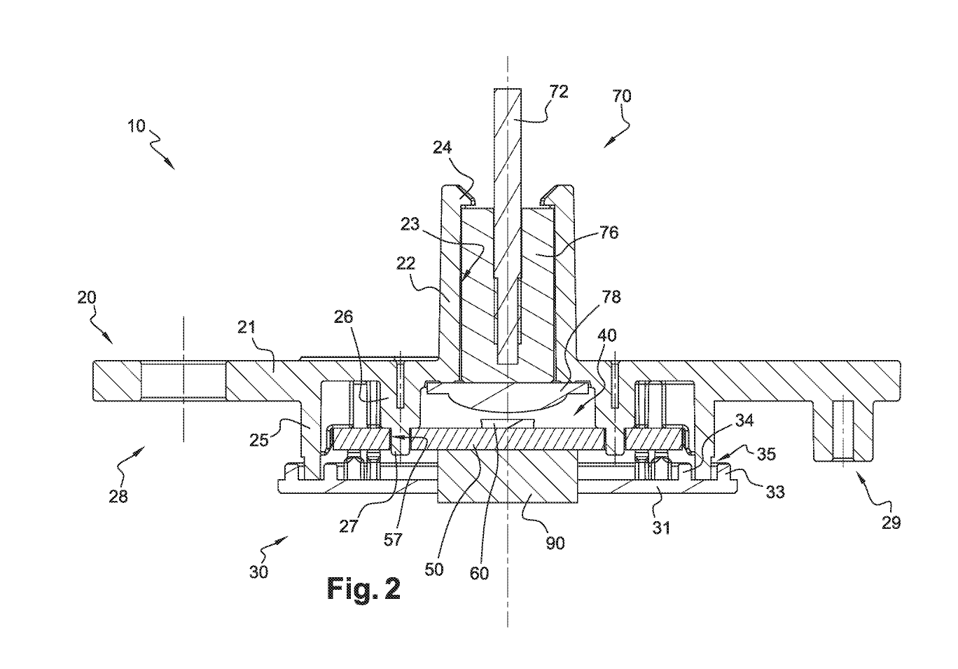

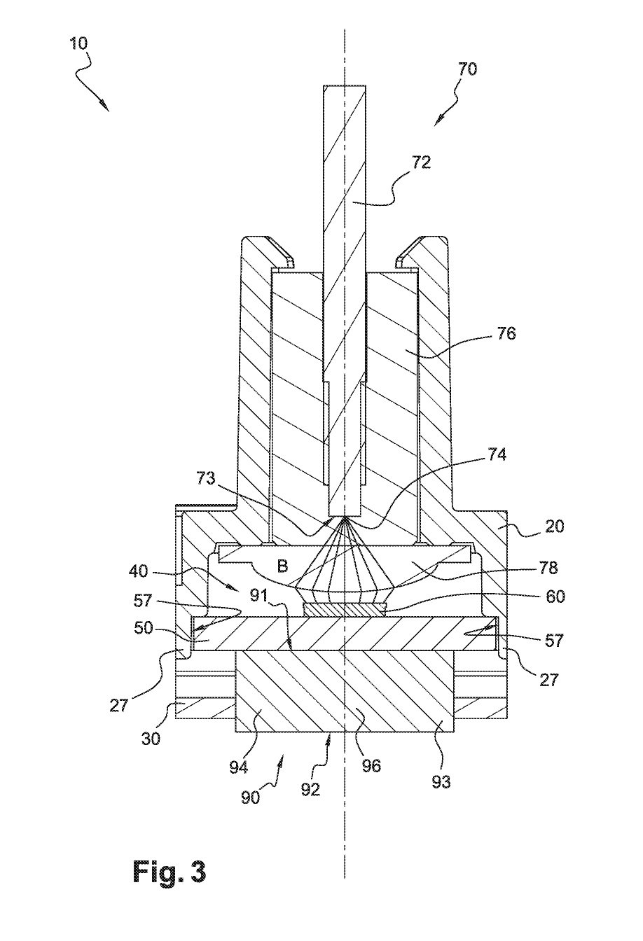

FIGS. 1 to 3 show a light module 10.

Module 10 is designed for illuminating an outer component 2 of a vehicle 1, partly and schematically showed only on FIG. 1 for simplification purpose.

Module 10 comprises a housing 20, a cover 30, a printed circuit board 50, a light source 60, a light guide 70, a connection system 80, and a heatsink insert 90. Housing 20 and cover 30 delimit a watertight inner space 40 between them. Space 40 receives PCB 50, on which source 60 is mounted. Guide 70 is mounted in housing 20, facing source 60.

Housing 20 is designed for fastening module 10 to vehicle 1, preferably directly to component 2. Housing 20 is also designed for receiving guide 70, PCB 50, then cover 30 to close space 40.

Housing 20 comprises a main body 21 shaped has an elongated plate. Housing 20 comprises a protrusion 22 formed on the outer side of body 21 and walls 25 formed on the inner side of body 21.

Protrusion 22 has a tubular shape and delimits a hollow recess 23 for receiving part of guide 70. Recess 23 is open opposite cover 30, such that guide 70 can extend outside module 10. Opposite cover 30, the outer end of protrusion 22 is provided with hooks 24 for retaining guide 70 in recess 23.

Walls 25 extend perpendicular to body 21 and along a square profile having curved angles. Walls 25 delimit space 40 together with body 21 and cover 30. Inside space 40, two separate stems 26 extend perpendicular to body 21. Opposite body 21, each stem 26 has an end portion forming a lug 27 of reduced diameter. Lugs 27 are designed for tight fitting into complementary apertures 57 formed in PCB 50, as detailed here-below.

Opposed ends of body 21 are provided with fastening means 28 and 29, namely a bore 28 and a reamed portion 29. Means 20 are used to fasten housing 20 to a support element, which may belong to component 2.

Cover 30 is mounted on housing 20 for closing space 40, after PCB 50 has been positioned therein.

Cover 30 comprises a main body 31 shaped has an elongate plate, and two inner walls 33 and 34 formed on the inner side of body 31. Each wall 33 and 34 extends along a square profile having curved angles. Between walls 33 and 34 is delimited an assembly path 35 for receiving walls 25.

Housing 20 and cover 30 are watertight sealed relative to each other at the junction of walls 25 and assembly path 35, for example by ultrasonic or laser welding.

PCB 50 is fastened to housing 20 inside space 40. PCB 50 is provided with conductive tracks and connection holes, not shown for simplification purpose. PCB 50 is designed for mechanically supporting and electrically connecting electronic components, such as source 60 and system 80.

Housing 20 and PCB 50 are provided with complementary indexing means 27 and 57 tightly fitted relative to each other, for directly positioning source 60 mounted PCB 50 relative to guide 70 mounted in housing 20.

Indexing means 27 and 57 allow a precise positioning of source 60 relative to guide 70, without influence of manufacturing tolerances of housing 20, cover 30 and PCB 50, and without influence of eventual assembly shifts between housing 20, cover 30 and board 50. The position of source 60 relative to indexing apertures 57 provided on PCB 50 is known with great precision. The position of guide 70 relative to indexing lugs 27 provided on housing 20 is also known with great precision. The indexing means 27 and 57 are fitted without clearance between them. Thus, source 60 can be positioned with great precision relative to guide 70, in particular to entry opening 73 and focus point 74.

On the examples of the figures, indexing means 27 and 57 have complementary circular transversal sections. Alternately, indexing means 27 and 57) can have complementary non-circular transversal sections.

According to a particular embodiment not shown, indexing means 27 and 57 can be constituted by only one lug 27 and one aperture 57. In this case, indexing means 27 and 57 have non-circular transversal sections.

According to another particular embodiment not shown, indexing means 27 and 57 can be constituted by at least one aperture formed in housing 20 and at least one lug belonging to PCB 50.

Light source 60 may be a light-emitting diode. Source 60 is configured for emitting an illumination beam B, for example within a cone having an apex angle of 100 degrees. Source 60 is fixedly mounted on PCB 50. For example, source 60 is provided with connection pins inserted in holes of PCB 50.

Light guide 70 is mounted in housing 20 facing source 60. Guide 70 extends at least partly outside space 40 for guiding beam B along component 2.

Guide 70 comprises an optical fiber 72, an abutment 76 and a lens 78.

Fiber 72 extends outside space 40 for guiding beam B along component 2. Fiber 72 has a diameter of approximately 2 or 3 millimeters. Fiber 72 has an inner end provided with an entry opening 73 facing source 60. Fiber 72 has an outer end not shown on the figures for simplification purpose. Beam B enters through opening 73 and is guided along fiber 72.

Abutment 76 has a cylindrical shape and is made of a transparent material. Inner end and entry opening 73 of fiber 72 are integrated inside abutment 76, for example by screwing, clipping or overmolding. Abutment 76 is positioned in recess 23, with hooks 24 in retaining contact with its outer surface.

Lens 78 is positioned between source 60 and opening 73, such that beam B emitted by source 60 is focalized toward opening 73. Lens 78 may have a specific convergent shape, entirely focalizing beam B on a focus point 74 located at the precise center of opening 73. Lens 78 is transparent, while housing 20 and cover 30 may be opaque, thus ensuring that beam B it transmitted outside module 10 only through guide 70.

Thanks to the configuration of light guide 70, the loss of illumination flow between light source 60 and optical fiber 72 can be greatly and easily reduced, inducing a lower electric consumption and higher durability of light source 60.

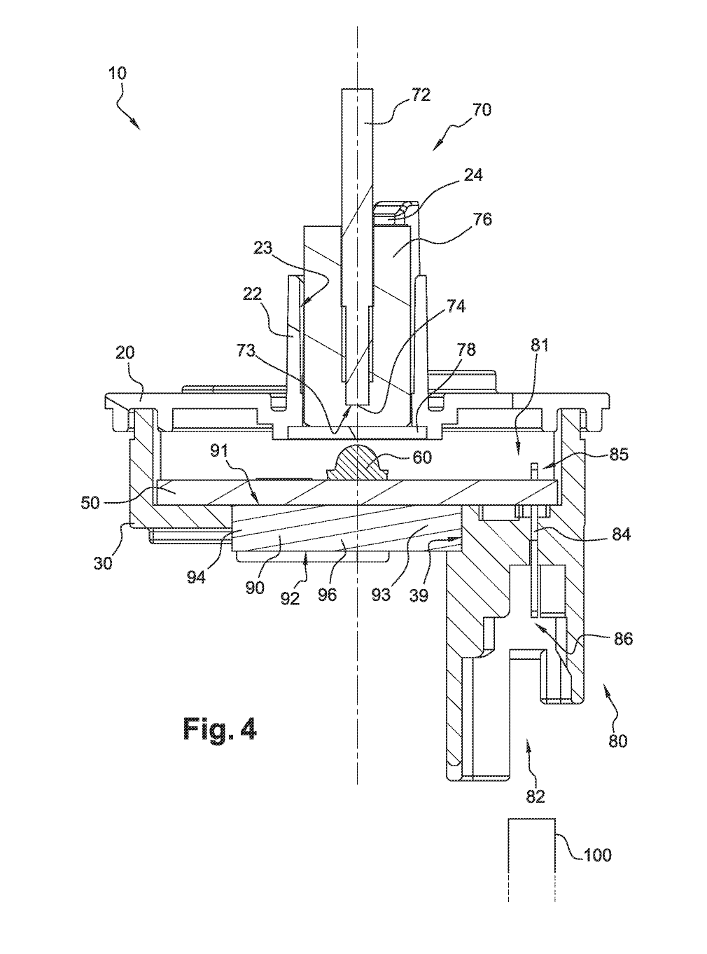

Connection system 80 is designed for connecting PCB 50 to another device outside module 10, for example the electronic control unit of vehicle 1. System 80 is described in more details here below in reference to FIG. 4.

Heatsink insert 90 is integrated to cover 30, for example by overmolding, or any other suitable technique. While housing 20 and cover 30 are made of plastic materials, insert 90 is made of metal so as to have good heat conduction. Insert 90 may be made of aluminum alloy, for a good compromise between heat conduction, weight and cost. Insert 90 may be a rectangular parallelepiped, easy and cheap to manufacture.

Insert 90 has an inner surface 91 positioned in contact with PCB 50 and an outer surface 92 extending outside space 40, in contact with ambient air.

Thus, the heat emitted by source 60 is transferred onto heatsink insert 90 via PCB 50. This provides cooling of module 10 and prevents source 60 from overheating and overaging.

Insert 90 has two lateral portions 93 and 94 separated by a central portion 96. For improved efficiency, source 60 is mounted on PCB 50 opposite insert 90. Source 60 may be mounted on PCB 50 opposite central portion 96 of insert 90.

The disclosure also concerns a process for manufacturing module 10. Insert 90 is integrated to cover 30 by overmolding or fitting.

In a first embodiment of the process, system 80 comprises one or several pins 84 integrated through cover 30 by overmolding or fitting. Thus, cover 30 and space 40 are watertight sealed in the area of system 80.

In a second embodiment of the process, system 80 comprises one or several pins 84 passing through cover 30 and fastened to PCB 50. Cover 30 is watertight sealed in the area of system 80 when a connector plug 100 is secured in an outer portion 82 of system 80.

A second embodiment of module 10 is represented on FIG. 4. In this embodiment, elements similar to the first embodiment have the same references and work in the same way. Only the differences with respect to the first embodiment are described hereafter.

In this embodiment, insert 90 is thicker than in the first embodiment. Thus, weight of module 10 can be reduced. During overmolding, lateral portion 93 of insert 90 is encased in a recess 39 of the cover 30. Said recess 39 forms an abutment opposite PCB 50.

System 80 has an inner portion 81 provided with a male configuration and fitted into PCB 50. System 80 has an outer portion 82 provided with a female configuration, designed to receive a connector plug 100, schematically and partly shown on FIG. 4.

System 80 comprises at least one pin 84 extending through cover 30, between portions 81 and 82. Pin 84 has a first end 85 projecting in inner portion 81 and connected to PCB 50. Pin 84 has a second end 86 projecting in portion 82 and located outside cover 30. As shown on the figures, system 80 may comprise several pins 84 extending through cover 30.

Watertight sealing of cover 30 in the area of system 80 is provided by fitting or overmolding of pins 84 through cover 30.

Alternately, cover 30 can be provided with holes having the dimensions of pins 84, ready to be traversed by pins 84, which are then welded on PCB 50. Consequently, cover 30 is not watertight near pins 84.

In this configuration, watertight sealing of module 10 and space 40 is ensured when plug 100 is fitted into the female socket of portion 82. Outer ends 86 of pins 84 are received in plug 100, while outer surfaces of plug 100 are tightly fitted in portion 82.

Other non-shown embodiments of a light module 10 can be implemented within the scope of the invention. In addition, technical features of the different embodiments can be, in whole or part, combined with each other. Thus, light module 10 and its manufacturing process can be adapted to the specific requirements of the application.

1. A light module for illuminating an outer component of a vehicle, the light module comprising:
a housing for fastening the light module to the vehicle;
a cover mounted on the housing;
an inner space delimited between the housing and the cover;
a printed circuit board mounted in the inner space;
a light source mounted on the printed circuit board and configured for emitting an illumination beam; and
a light guide mounted in the housing facing the light source and extending outside the inner space for guiding the illumination beam along the outer component; and
a connection system for connecting the printed circuit board outside the light module;
wherein the housing and the cover are each made of a plastic material; and
wherein the cover integrates, on the one hand, the connection system and, on the other hand, a heatsink insert made of metal and having an inner surface in contact with the printed circuit board and an outer surface extending outside the inner space of the light module.

2. The light module according to claim 1, wherein the light source is mounted on the printed circuit board opposite the heatsink insert.

3. The light module according to claim 1, wherein the light source is mounted on the printed circuit board opposite a central portion of the heatsink insert.

4. The light module according to claim 1, wherein the heatsink insert is made of aluminium alloy.

5. The light module according to claim 1, wherein the connection system comprises at least one pin extending through the cover, and having a first end connected to the printed circuit board and a second end located outside the cover.

6. The light module according to claim 5, wherein the connection system comprises several pins extending through the cover.

7. The light module according to claim 1, wherein the connection system has an inner portion provided with a male configuration and fitted into the printed circuit board.

8. The light module according to claim 1, wherein the connection system has an outer portion provided with a female configuration for receiving a connector plug.

9. The light module according to claim 8, wherein the outer portion is designed to provide a sealed connection once the connector plug is secured therein.

10. A process for manufacturing the light module, wherein the light module includes a housing for fastening the light module to the vehicle, a cover mounted on the housing, an inner space delimited between the housing and the cover, a printed circuit board mounted in the inner space, a light source mounted on the printed circuit board and configured for emitting an illumination beam, a light guide mounted in the housing facing the light source and extending outside the inner space for guiding the illumination beam along the outer component, and a connection system for connecting the printed circuit board outside the light module, wherein the housing and the cover are each made of a plastic material, and wherein the cover integrates, on the one hand, the connection system and, on the other hand, a heatsink insert made of metal and having an inner surface in contact with the printed circuit board and an outer surface extending outside the inner space of the light module, wherein the heatsink insert is integrated to the cover by overmolding or fitting.

11. The process according to claim 10, wherein the connection system comprises one or several pins integrated through the cover by overmolding or fitting, such that the cover is watertight sealed in the area of the connection system.

12. The process according to claim 10, wherein the connection system comprises one or several pins passing through the cover and fastened to the printed circuit board, such that the cover is watertight sealed in the area of the connection system when a connector plug is secured in an outer portion of the connection system.
